(19) United States
(12) Patent Application Publication
(10) Pub. No.: US 2013/0305641 A1
(43) Pub. Date: Nov. 21, 2013

(54) COMPOSITE BUILDING PANEL

(71) Applicant: WILLIAM R. SLEEMAN, Ada, MI (US)

(72) Inventor: WILLIAM R. SLEEMAN, Ada, MI (US)

(21) Appl. No.: 13/953,178

(22) Filed: Jul. 29, 2013

Related U.S. Application Data
(62) Division of application No. 11/803,638, filed on May 15, 2007, now abandoned.

(51) Int. Cl. E04C 2/28; E04C 2/24; B32B 21/08; B32B 13/12; B32B 27/06; B32B 27/08

(52) U.S. Cl. CPC E04C 2/28; B32B 27/065; B32B 27/08; B32B 21/08; B32B 13/12; E04C 2/24
USPC 52/309.1; 428/411.1; 428/537.1; 428/446; 428/220; 428/423.1; 428/304.4

(57) ABSTRACT

A composite panel useful for efficient and economic construction of a building wall or roof includes at least a first rigid structural layer and a cross-linked polymer film layer bonded to and covering a first major planar surface of the rigid structural panel. The panels integrate sheathing or decking and weatherproofing into an integrated product that may be installed on building frame members in substantially the same way that ordinary sheathing or decking is conventionally installed.

### CROSS-REFERENCE TO RELATED APPLICATION

AND CLAIM TO PRIORITY

This application is a divisional of and claims priority under 35 U.S.C. §120 to commonly owned, co-pending, related U.S. patent application Ser. No. 11/803,638, filed May 15, 2007, entitled COMPOSITE BUILDING PANEL.

### FIELD OF THE INVENTION

This invention relates to building construction materials and more particularly to composite panels for roofing, exterior building wall and interior building wall applications.

### BACKGROUND OF THE INVENTION

Conventional building construction typically involves forming walls and roofs by fastening sheathing sheets or decking sheets of material, such as plywood or the like, to structural framing members, such as rafters, purlins, studs, joists and beams. Insulating materials are typically applied in a separate operation after the sheathing and decking have been installed. Similarly, weatherproofing materials are typically applied in a separate installation operation after the sheathing and decking have been installed.

Composite panels have been developed which incorporate both sheathing or decking and insulation in a laminated form. However, weatherproofing must be applied and/or installed in a separate operation, such as by installation of singles, roof membranes, aluminum siding, vinyl siding, or the like.

### SUMMARY OF THE INVENTION

The invention provides a composite panel with integrated structural sheathing or decking and weatherproofing which is useful for efficiently and/or economically constructing a building roof or wall.

In accordance with an aspect of the invention, there is provided a composite panel having at least a first rigid structural layer and a cross-linked polymer film layer bonded to and covering a first major surface of the rigid structural panel.

In accordance with another aspect of the invention, there is provided a process for constructing a roof, exterior wall or interior wall of a building performing steps of providing a plurality of composite panels having at least a first rigid structural layer and a cross-linked polymer film layer bonded to and covering a first major planar surface of the first rigid structural panel; and fastening the composite panels to structural members of a building in an edge-to-edge abutting relationship with the cross-linked polymer film being exposed and opposite a side facing the structural members.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a cross-sectional view of a composite panel in accordance with an embodiment of the invention.

FIG. 2 is a cross-sectional view of a second embodiment of a composite panel in accordance with the invention.

FIG. 3 is a perspective view of a building having a roof and a wall comprising a plurality of composite panels in accordance with the invention.

### DETAILED DESCRIPTION OF PREFERRED EMBODIMENTS

The expression “rigid structural layer” as used herein refers to a panel substrate that is relatively resistant to deflection or deformation by an applied force. In general, the rigid structural layer will have a stiffness that is comparable to commercially available plywood sheets having a thickness of at least about one-quarter inch (6.35 millimeters). In general, it is desirable that the rigid structural layer have a modulus of elasticity (Young's modulus) of at least about 5×10⁵ lb/in² (3.4 MPa), more desirably a modulus of elasticity (Young's modulus) of at least about 7×10⁵ lb/in² (4.8 MPa); and a thickness of at least about 0.15 inches (3.8 milli-meters). Of course, a comparable stiffness can be achieved using thinner materials having a higher modulus of elasticity or thicker materials having a lower modulus of elasticity.

Examples of suitable materials that may be used for making the rigid structural layer include engineered woods and concrete. The expression “engineered wood” includes a range of wood products which are manufactured by binding together wood strands, particles, fibers or the like with adhesives to form a composite board. Examples include glued laminated timber, plywood, oriented strand board (OSB), waferboard, particleboard and various fiberboards, including masonite, medium-density fiberboard and hardboard. Other suitable materials include cement board, gypsum board and papercrete. Papercrete consists of re-pulped paper fiber combined with portland cement or clay.

The rigid structural layer, typically has length and width dimensions similar to the dimensions of commercially available plywood sheets, i.e., typically about 8 feet long (2.4 meters) and about 4 feet wide (1.2 meters). It should be recognized that rigidity or stiffness is also dependent on the length and width dimensions of the rigid structural layer. For example, longer rigid structural layers may be utilized, but may require greater thickness and/or material having a higher modulus of elastically in order to maintain the desired rigidity or stiffness.

The cross-linked polymer film is typically formed by applying a thermosetting resin composition (i.e., one that cross-links or cures in an irreversible chemical reaction to form a layer bonded to the rigid structural layer), and subsequently curing or thermosetting the composition by chemical cross-linking. Preferably, the liquid thermosetting resin composition is applied by spraying. However, other application techniques, such as brushing, rolling, curtain coating and the like may be employed. Preferably, curing occurs relatively rapidly at or near ambient temperature without the need for thermal or radiative initiation. However, thermally or radiatively activated thermosetting resin compositions may be employed if desired. Preferred thermosetting compositions that may be employed for forming the cross-linked polymer film include thermosetting polyurethane resins, thermosetting polyurea resins and thermosetting polyurea-polyurethane hybrid resin systems. However, other thermosetting resin compositions that cure by chemical cross-linking to form a suitable weatherproofing film may be used, such as moisture curable polyurethanes (either one component or two component types), acrylics, epoxies, polyesters, phenolics, polyaspartics, etc.

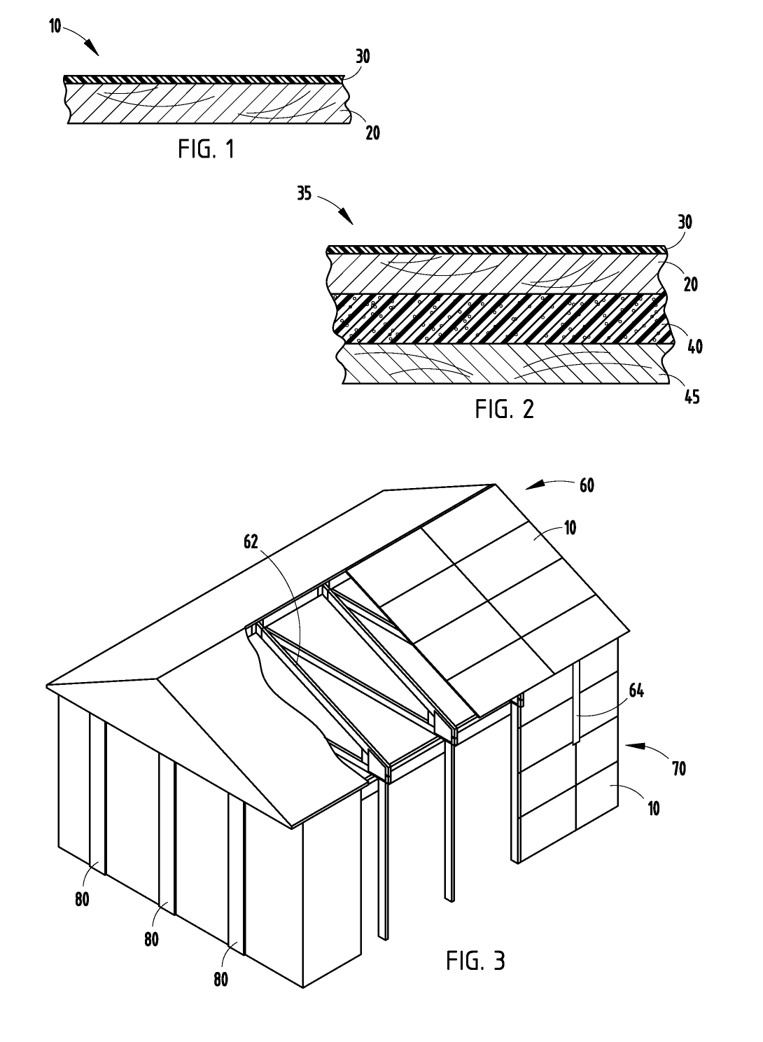

As shown in FIG. 1, a composite panel 10 in accordance with the invention includes at least a first rigid structural layer 20 and a cross-linked polymer film layer 30 bonded to and covering a first major planar surface of the rigid structural panel. In general, polyurethane, polyurea and polyurea-polyurethane hybrid thermosetting resin compositions may be applied directly to wood panels, engineered wood panels and other panels comprised largely of cellulosic materials without the need for adhesion promoters or other surface preparation to facilitate or enhance bonding between the cured film and the rigid structural layer. However, depending on the selected rigid structural layer and the selected cross-linked polymer film, the use of surface treatments and/or adhesion promoters may be desirable to establish suitable bonding between the rigid structural layer and the cross-linked polymer film layer or to enhance such bonding. For example, in the case of a cementous rigid structural layer, it may be desirable to apply a primer composition containing an organosilane adhesion promoter to the surface of the rigid structural layer to which the thermosetting resin composition is applied.

As shown in FIG. 2, the composite panels of this invention, in a certain embodiment 35, may further comprise a layer of plastic foam insulation 40 attached to and covering a second major planar surface of the first rigid structural panel 20 that is opposite the first major planar surface covered by the cross-linked polymer film 30. Optionally, the embodiment shown in FIG. 2 may further comprise a second rigid structural layer 45 attached to and covering a major planar surface of the plastic foam insulation opposite a surface of the plastic foam insulation attached to the first rigid structural layer 20. In this arrangement, the foam insulation is sandwiched between two structural layers to provide a weatherproof composite panel that can be fastened directly to building frame members to form a weatherproof roof or wall in a single installation step. Joints formed at the abutting edges of adjacent panels 10 may then be sealed by taping over the seams and spraying (or otherwise applying) a thermosetting resin composition over the tape and at least slightly beyond the edges of the tape. As an alternative, joints may be filled with a polyurethane, polyurea, silicone, or other joint sealant, and, optionally covered (such as by spraying) with a thermosetting resin composition. The thermosetting resin composition may also be sprayed or otherwise applied over exposed portions of fasteners (e.g., nail heads) used to attach the panels 10 to building frame members to conceal and/or seal around the fasteners. A preferred plastic foam insulation comprises polystyrene. Other plastic foam insulation materials that may be employed include polyurethanes, polyureas, polyurea-polyurethane hybrids, polyisocyanurates, phenolic polymers, polyesters and epoxides.

As shown in FIG. 3, a roof 60 of a building 62 is constructed by fastening panels 10 to rafters or other building frame members so that the panels 10 are in edge-to-edge abutment. Thereafter, seams are taped over with any suitable tape 64, such as a vinyl adhesive tape, a butyl rubber adhesive tape, or generally any other tape comprising a plastic film that may be adhesively bonded to the polymer film layer of panels 10 to cover seams at abutting panel edges. Thereafter, application of a thermosetting resin composition, such as a polyurethane, polyurea or polyurea-polyurethane hybrid resin composition is employed to create a unitary roof in which the individual polymer film layers of the composite panel 10 are integrated into a continuous weatherproof layer covering an entire roof. Depending on the type of building, the roof panels may comprise layers 20 and 30; layers 20, 30 and 40; or layers 20, 30, 40 and 45.

An exterior wall of a building 70 may be constructed in a similar fashion by fastening panels 10 to studs or other building frame members and sealing the resulting joints of abutting edges of panels 10 as described above. Depending on the type of building, the wall panels may comprise only a rigid layer 20 and a film layer 30; these layers plus an insulative layer 40; or an insulative layer 40 between rigid layers 20 and 45, and a film layer 20, as shown in FIG. 2.

Interior building walls may be constructed in a similar fashion, using the embodiment of FIG. 1, which comprises only a rigid panel layer 20 and a film layer 30; the embodiment of FIG. 2 comprises layers 20, 30, 40 and 45; or an embodiment comprising layers 20, 30 and 40. Such interior walls may be useful for constructing clean rooms for manufacturing sensitive products such as electronic components, pharmaceuticals, etc.

Also as shown in FIG. 3, ornamental structures, such as batten-like strips 80 of material may be attached to roof or wall structures, either with adhesives or fasteners such as nails.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A composite panel comprising:
at least a first rigid structural layer; and
a cross-linked polymer film layer bonded to and covering a first major planar surface of the first rigid structural panel.

2. The composite panel of claim 1, wherein the first rigid structural layer is made of an engineered wood product.

3. The composite panel of claim 1, wherein the first rigid structural layer is made of particleboard, plywood or oriented strand board.

4. The composite panel of claim 1, wherein the first rigid structural layer is made of lumber or glued laminated timber.

5. The composite panel of claim 1, wherein the first rigid structural layer is made of a fiberboard selected from the group consisting of particleboard, medium-density fiberboard and hardboard.

6. The composite panel of claim 1, wherein the first rigid structural layer is made of masonite.

7. The composite panel of claim 1, wherein the first rigid structural layer is made of concrete.

8. The composite panel of claim 1, wherein the first rigid structural layer has a modulus of elasticity (Young's modulus) of at least 5×10⁵ lb/in² (3.4 MPa) and a thickness of at least 0.15 inches (3.8 millimeters).

9. The composite panel of claim 1, wherein the first rigid structural layer has a modulus of elasticity (Young's modulus) of at least 7×10⁵ lb/in² (4.8 MPa) and a thickness of at least 0.15 inches (3.8 millimeters).

10. The composite panel of claim 1, wherein the cross-linked polymer film is a thermoset polyurethane resin, a thermoset polyurea resin, or a thermoset polyurea-polyurethane hybrid resin system.

11. The composite panel of claim 1, further comprising a layer of plastic foam insulation attached to and covering a second major planar surface of the first rigid structural panel that is opposite the first major planar surface covered by the cross-linked polymer film.

12. The composite panel of claim 11, further comprising a second rigid structural layer attached to and covering a major planar surface of the plastic foam insulation opposite a surface of the plastic foam insulation attached to the first rigid structural layer.

13. The composite panel of claim 11, wherein the layer of plastic foam insulation comprises polystyrene.

14. The composite panel of claim 11, wherein the layer of plastic foam insulation comprises at least one foamed plastic material selected from the group consisting of polyurethanes, polyureas, polyurea-polyurethane hybrids, polyisocyanurates, phenolic polymers, polyesters and epoxides.

15. A building comprising:
a roof, exterior wall or interior wall comprised of a plurality of panels having abutting edges, each panel including at least a first rigid structural layer and a cross-linked polymer film layer bonded to and covering a first major planar surface of the first rigid structural panel.
